(19) United States
(12) Patent Application Publication
(10) Pub. No.: US 2006/0047879 A1
(43) Pub. Date: Mar. 2, 2006

(54) Use of card presence to determine maximum bus speed

(75) Inventors: Mark Elliott Hack, Cedar Park, TX (US); Steven Paul Hartman, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/932,705

(22) Filed: Sep. 2, 2004

(51) Int. Cl. G06F 13/00

(52) U.S. Cl. 710/302

(57) ABSTRACT

A mechanism for determining the maximum speed at which a PCI bus should be set. The mechanism uses a card presence pin provided for in the PCI specification to detect the number of devices residing on the PCI bus. The mechanism then sets the PCI bus speed to the highest speed possible for the actual number of devices on the PCI bus and not the maximum number of devices the PCI bus can handle.

### BACKGROUND OF THE INVENTION

1. Technical Field

The present invention relates to a method of determining the maximum speed at which a PCI or similar bus should be set. In particular, the present invention relates to using a card presence indicator to determine the maximum speed at which a PCI or similar bus should be set.

2. Description of Related Art

In conventional computing systems, when several Peripheral Component Interface (PCI) devices are possible on the same PCI bus, the bus speed is limited by the total number of devices on the bus.

A conventional computing system is composed of many complex components and all of these components need to communicate with each other in a fast and efficient manner. Thus, the conventional computing system contains buses which provide a channel or path between the components within a computer. One of the buses within the conventional computing system is the PCI bus.

A typical computer has two key buses. The first one, known as the system bus or local bus, connects the microprocessor (central processing unit) and the system memory. Other buses, such as the ISA and PCI buses, connect to the system bus through a bridge, which is a part of the computer's chipset and acts as a traffic cop, integrating the data from the other buses to the system bus.

PCI is a synchronous bus architecture with all data transfers being performed relative to a system clock. The initial PCI specification permitted a maximum clock rate of 33 MHz allowing one bus transfer to be performed every 30 nanoseconds. Later, revisions of the PCI specification extended the bus definition to support operation at 66-133 MHz and higher bus speeds.

PCI implements a 32-bit multiplexed Address and Data bus. It architects a means of supporting a 64-bit data bus through a longer connector slot, but most of today's personal computers support only 32-bit data transfers through the base 32-bit PCI connector. At 33 MHz, a 32-bit slot supports a maximum data transfer rate of 132 MBytes/sec, and a 64-bit slot supports 264 MBytes/sec.

PCI supports a rigorous auto configuration mechanism. Each PCI device includes a set of configuration registers that allow identification of the type of device (SCSI, video, Ethernet, etc.) and the company that produced it. Other registers allow configuration of the device's I/O addresses, memory addresses, interrupt levels, etc.

PCI defines support for both 5 Volt and 3.3 Volt signaling levels. The PCI connector defines pin locations for both the 5 Volt and 3.3 Volt levels. However, most early PCI systems were 5 Volt only, and did not provide active power on the 3.3 Volt connector pins. Over time more use of the 3.3 Volt interface is expected, but add-in boards which must work in older legacy systems are restricted to using only the 5 Volt supply. A “keying” scheme is implemented in the PCI connectors to prevent inserting an add-in board into a system with incompatible supply voltage.

PCI bus architecture is processor independent. PCI signal definitions are generic allowing the bus to be used in systems based on other processor families. PCI includes strict specifications to ensure the signal quality required for operation at 33 and 133 MHz. Components and add-in boards must include unique bus drivers that are specifically designed for use in a PCI bus environment. Typical transistor-transistor logic devices used in previous bus implementations such as Integrated Systems Architecture and Extended Industry-Standard Architecture are not compliant with the requirements of PCI. This restriction along with the high bus speed dictates that most PCI devices are implemented as custom Application-Specific Integrated Circuits (ASICs).

The higher speed of PCI limits the number of expansion slots on a single bus to no more than three or four, as compared to six or seven for earlier bus architectures. To permit expansion buses with more than three or four slots, the PCI Special Interest Group has defined a PCI-to-PCI Bridge mechanism. PCI-to-PCI Bridges are ASICs that electrically isolate two PCI buses while allowing bus transfers to be forwarded from one bus to another. Each bridge device has a “primary” PCI bus and a “secondary” PCI bus. Multiple bridge devices may be cascaded to create a system with many PCI buses.

When multiple cards are connected to a single PCI bus, the speed of the bus is currently limited depending on the load imposed on the bus. The normal technique used is to limit the bus speed based on the maximum potential load on the bus.

### SUMMARY OF THE INVENTION

The present invention provides a mechanism for determining the maximum speed at which a PCI bus should be set. The mechanism uses a card presence pin provided for in the PCI specification to detect the number of devices residing on the PCI bus. The mechanism then sets the PCI bus speed to the highest speed possible for the actual number of devices on the PCI bus and not the maximum number of devices the PCI bus can handle.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating an exemplary implementation of components in accordance with the present invention;

FIGS. 4A, 4B and 4C are diagrams of a PCI pin layout of a 5V and 3.3V system environment in accordance with a preferred embodiment of the present invention;

FIG. 5 is a flow diagram illustrating the process of setting the maximum speed for a PCI bus when the bus speed is set at chip rest in accordance with a preferred embodiment of the present invention;

FIG. 6 is a flow diagram illustrating the process of setting the maximum speed for a PCI bus when the bus speed may be set dynamically in accordance with a preferred embodiment of the present invention; and

FIG. 7 is a diagram illustrating the maximum bus speed depending on load in accordance with a preferred embodiment of the present invention.

### DETAILED DESCRIPTION OF THE PREFERRED EMBODIMENT

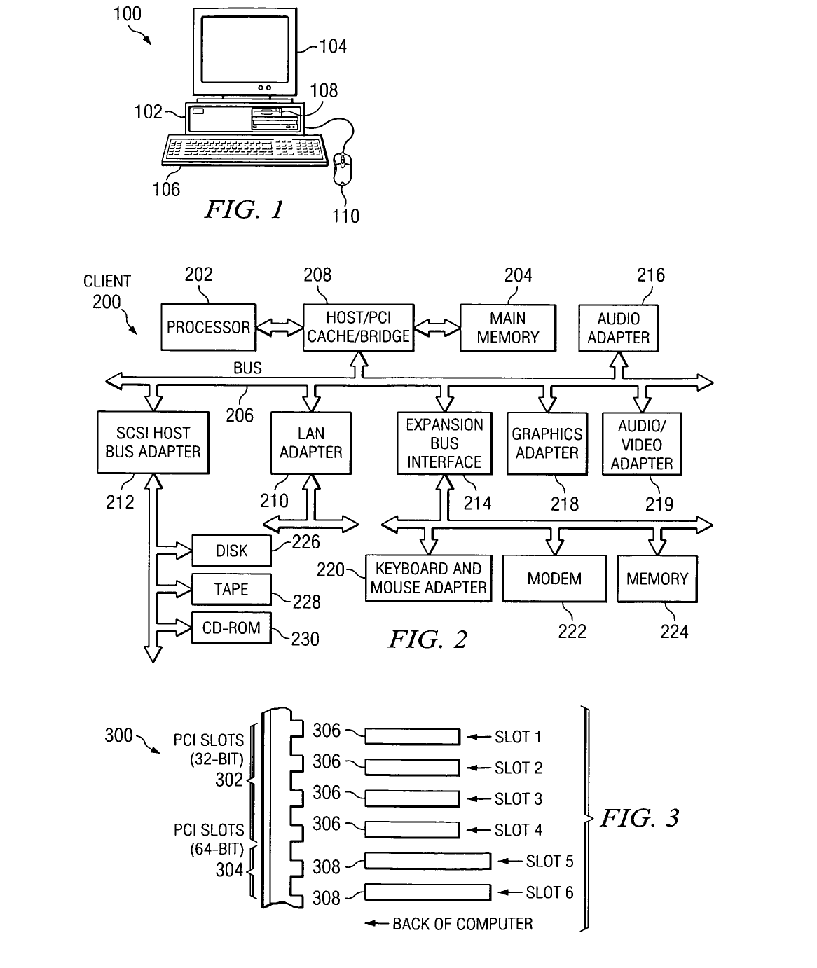

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 200. “JAVA” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface.

The processes of the present invention are performed by processor 202 using computer implemented instructions, which may be located in a memory such as, for example, main memory 204, memory 224, or in one or more peripheral devices 226-230.

The present invention provides a mechanism for determining the maximum speed at which a PCI bus should be set. The mechanism uses a card presence pin provided for in the PCI specification to detect the number of devices residing on the PCI bus. The mechanism then sets the PCI bus speed to the highest speed possible for the actual number of devices on the PCI bus and not the maximum number of devices the PCI bus can handle.

Turning now to FIG. 3, a diagram illustrating an exemplary implementation of component 208 in FIG. 2 is depicted in accordance with the present invention. Component 208 of FIG. 2 may contain multiple PCI slots 302 and 304. Within PCI slots 302, there may be multiple 32-bit PCI slots 306 and within PCI slots 306 may be multiple 64-bit PCI slots 308. In addition to the PCI slots 306 and 308, there may also be integrated PCI devices that may exist in system unit 102 of FIG. 1.

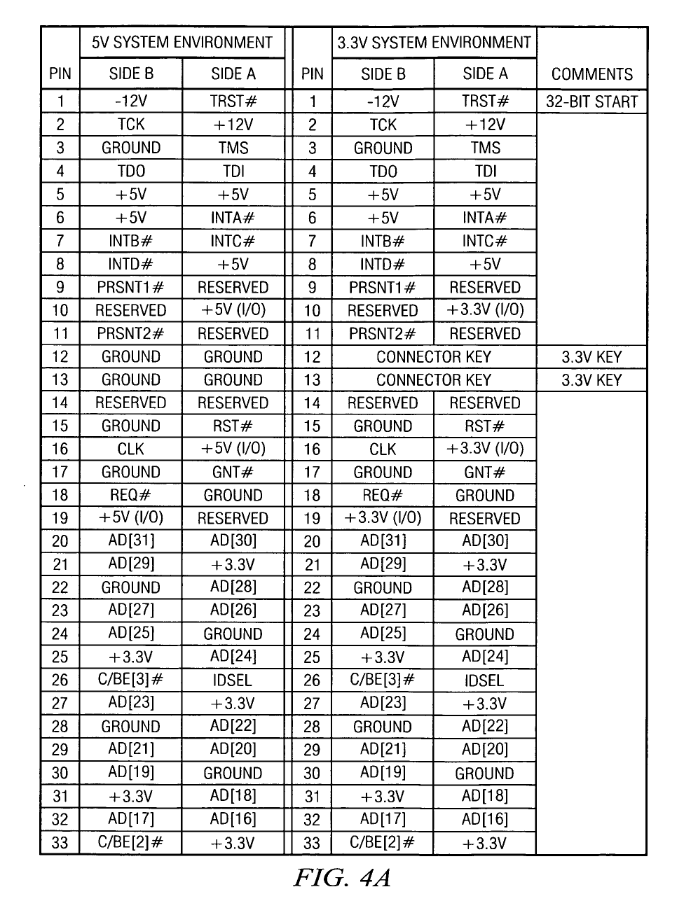

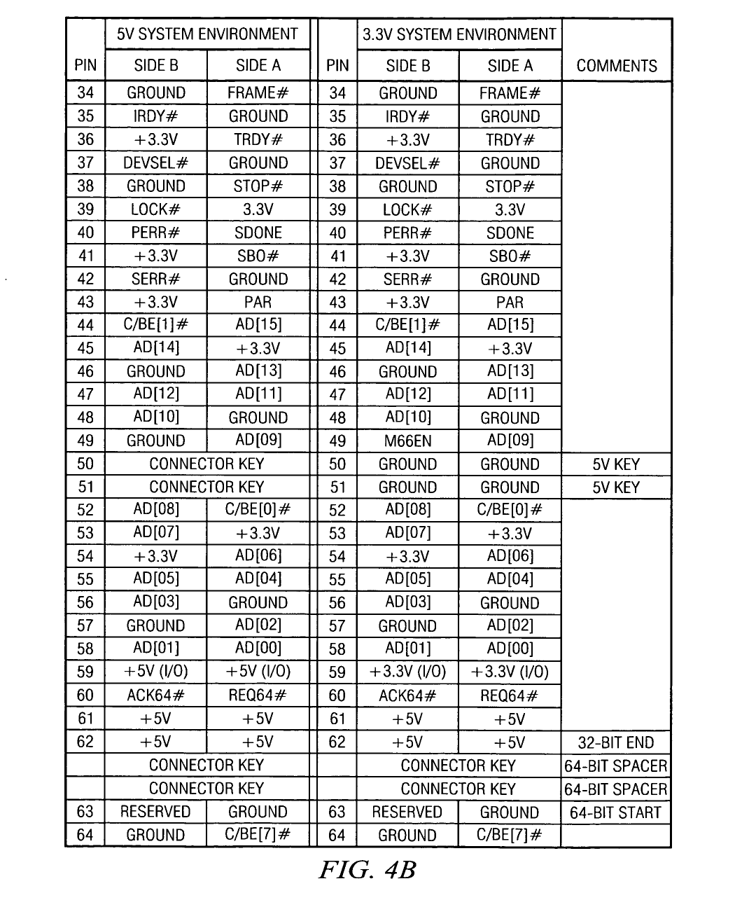

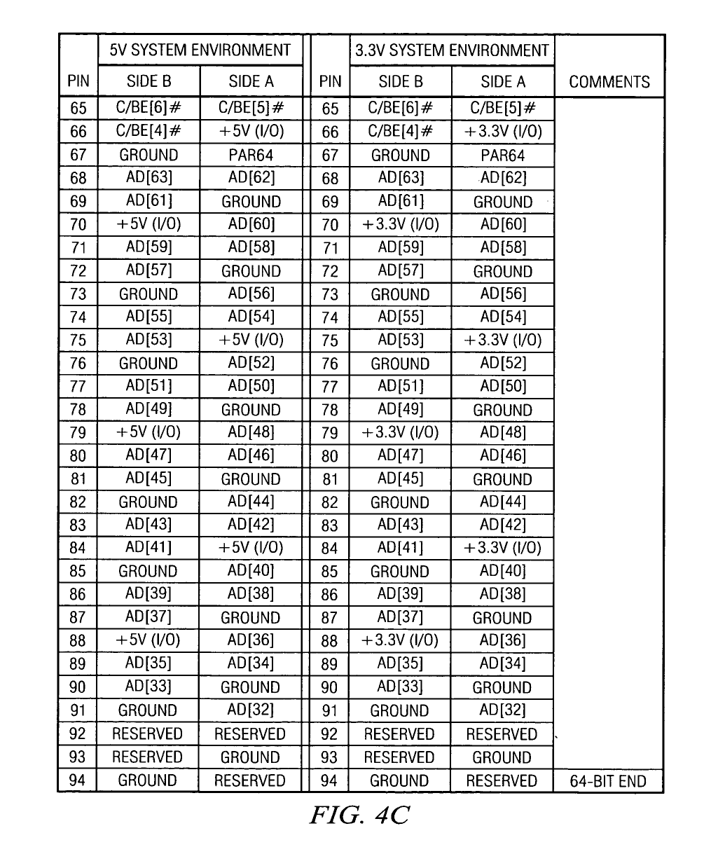

Turning now to FIGS. 4A, 4B and 4C, diagrams depicting the PCI pin layout of a 5V and 3.3V system environment in accordance with a preferred embodiment of the present invention are depicted. The pins which may be included on a PCI card are system pins, address and data pins, interface control pins, arbitration pins, error reporting pins, interrupt pins, cache support pins, 64-bit bus extension pins, JTAG/boundary scan pins and other additional pins.

System pins include a clock (CLK) pin, which provides the timing reference for all transfers on the PCI bus, and a reset (RST#) pin, which is driven active low to cause a hardware reset of a PCI device. Address and data pins include address and data pins, bus command and byte enables and parity pins. Address and data pins (AD[31:0]) transfers a 32-bit physical address during “address phases”, and transfers 32-bits of data information during “data phases”. Bus command and byte enables pins (C/BE[3:0]#) carry the bus command that defines the type of transfer to be performed during the address phase of a transaction of these signals. The Parity pin (PAR) provides even parity over the AD[31:0] and C/BE[3:0# signals. Even parity implies that there is an even number of ‘1’s on the AD[31:0], C/BE[3:0]#, and PAR signals.

Interface control pins include cycle frame, initiator ready, target ready, stop, lock, initialization device select, and device select. Cycle frame (FRAME#) is driven low by the initiator to signal the start of a new bus transaction. Initiator Ready (IRDY#) is driven low by the initiator as an indication it is ready to complete the current data phase of the transaction. Target Ready (TRDY#) is driven low by the target as an indication it is ready to complete the current data phase of the transaction. Stop (STOP#) is driven low by the target to request the initiator to terminate the current transaction. Lock (LOCK#) may be asserted by an initiator to request exclusive access for performing multiple transactions with a target. Initialization Device Select (IDSEL) is used as a chip select during PCI configuration read and write transactions. Device Select (DEVSEL#) is driven active low by a PCI target when it detects its address on the PCI bus.

Arbitration pins include a request (REQ#) which is used by a PCI device to request use of the bus and a grant pin (GNT#) which indicates that a PCI device's request to use the bus has been granted. Error reporting pins include a parity error pin (PERR#) which is used for reporting data parity errors during all PCI transactions except a “Special Cycle” and a system error pin (SERR#) which is for reporting address parity errors, data parity errors during a Special Cycle, or any other fatal system error. Interrupt pins (INTA#, INTB#, INTC#, and INTD#) are driven low by PCI devices to request attention from their device driver software.

Cache support pins, which are optional, are architected to permit cacheable memory to be implemented on a PCI bus. The cache support pins are rarely if ever implemented in today's PCI systems. Cache support pins include a snoop backoff (SBO#) that indicates a hit to a modified line when asserted and a snoop done (SDONE) that indicates the status of the snoop for the current access.

Other optional pins are the 64-bit bus extension pins and the JTAG/boundary scan pins. The 64-bit bus extension pins include address and data pins, (AD[63:32]), which are multiplexed on the same pins and provide 32 additional bits when operating in a 64-bit bus environment, bus command and byte enables pins, (C/BE[7:4]#), which are multiplexed onto the same pins and provide 4 additional bits when operating in a 64-bit bus environment. The 64-bit bus extension pins also include a request 64-bit transfer pin (REQ64#) which is asserted low by the initiator to indicate it desires a 64-bit transfer, acknowledge 64-bit transfer (ACK64#) which is asserted low by a target as an indication that it has decoded its address as the target of the current access, and is capable of performing a 64-bit transfer, and a parity pin (PAR64) that is the even parity bit that protects AD[63:32] and C/BE[7:41#. The JTAG/boundary scan pins allow components installed on a PCI add-in board to be exhaustively tested by serially scanning test patterns through each component. The JTAG/boundary scan pins include test clock (TCK), test data input (TDI), test output (TDO), test mode select (TMS) and test reset (TRST#).

Additional pins that are present on a PCI card are clock running, 66 MHZ enable and card present. The clock running pin (CLKRUN#) provides an optional signal used to facilitate stopping of the CLK signal for power saving purposes. The 66 MHZ enable pin (M66EN) is left “open” or disconnected on add-in boards that support operation with a 66 MHz CLK, and grounded on add-in boards that support operation with only a 33 MHz CLK. The card present pins (PRSNT[1:2]#), which is used in accordance with a preferred embodiment of the present invention, are used for two purposes: 1) to indicate that an add-in board is physically present, and 2) to indicate the power requirements of an add-in board. These are static signals that are either grounded or left open on the add-in board.

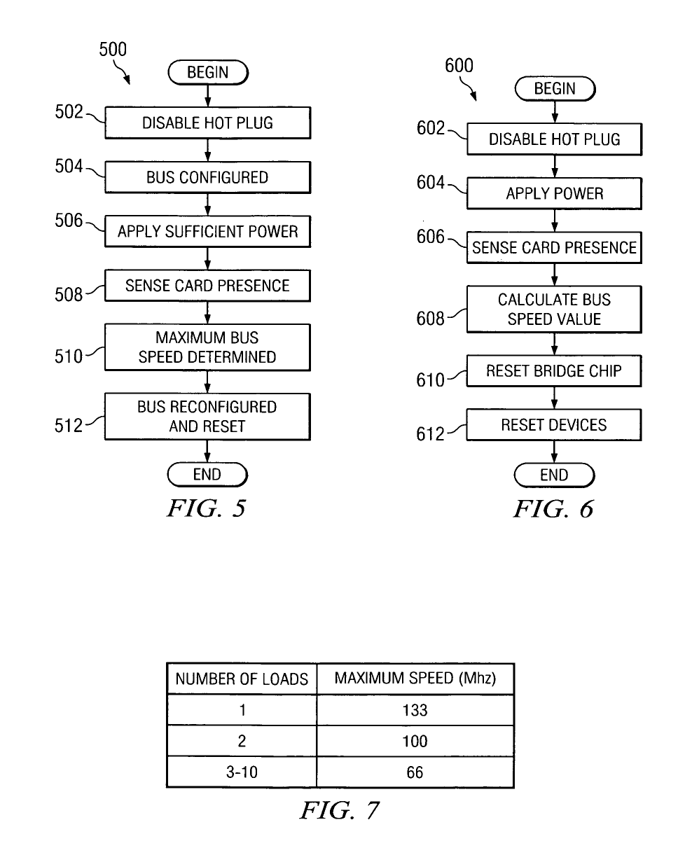

Turning now to FIG. 5, a flow diagram 500 illustrating the process of setting the maximum speed for a PCI bus when the bus speed is set at chip rest is depicted in accordance with a preferred embodiment of the present invention. In order to implement setting the speed of the PCI bus based on the actual number of devices connected rather than using the maximum possible devices, the system hot-plug capability must be disabled (block 502). This additional limitation is imposed because device hot plug cannot be fully supported at the same time as this technique is used, unless the number of devices which can be added to the bus does not require modification of the bus speed. Hot plug of devices allows devices to be removed, replaced or added to the system without powering down the data processing system. Although replacing a device would not hinder the implementation of the present invention removing or adding a device may require an increase or decrease of the bus speed. Thus, the process of the present invention does not allow hot plug. After hot plug has been disabled, the bus is configured at its lowest speed, which in the case of PCI 1.0 is 33 MHz (block 504) although the lowest speed may vary depending on implementation. Then sufficient power is applied to the devices in order to detect the devices using the card present pin (PRSNT[1:2]#) (block 506). The card presence is detected for each integrated card and any additional card that exists within the system (block 508). The maximum bus speed is then determined based upon the number of devices that are present (block 510). Finally, the bus is reconfigured to operate at the determined speed and the bus is reset (block 512), thereby terminating the process.

FIG. 6 depicts a flow diagram 600 illustrating the process of setting the maximum speed for a PCI bus when the bus speed may be set dynamically in accordance with a preferred embodiment of the present invention. Once again, in order to implement setting the speed of the PCI bus based on the actual number of devices connected rather than using the maximum possible devices, the system hot-plug capability must be disabled (block 602). After hot plug has been disabled, power is applied in a normal sequence (block 604). Card presence is detected for each integrated card and any additional card that exists within the system (block 606). The maximum bus speed is then determined based upon the number of devices that are present (block 608). The bus is reset to operate at the determined speed (block 610). Finally, all of the devices connected to the PCI bus are reset to remove any error by using normal PCI reset sequences (block 612) thereby terminating the process.

FIG. 7 is a diagram illustrating the maximum bus speeds depending on load in accordance with an exemplary embodiment of the present invention. In this diagram if only one device is present on the PCI bus, then the bus speed may be set to 133 MHz, for example. If two devices are present, then the bus speed may be set to 100 MHz for example. Likewise, if three or more devices are present on the PCI bus, then the bus speed may be set to 66 MHz for example.

In summary, the present invention provides a mechanism for minimizing effective memory latency without unnecessary cost through fine-grained software-directed data prefetching using integrated high-level and low-level code analysis and optimizations. The mechanism identifies and classifies streams based on reuse analysis and dependence analysis. The mechanism makes use of the information from high-level loop transformations, data remapping, and work data-set analysis to identify which data is most likely to incur a cache miss. The mechanism exploits effective hardware prefetching through high-level loop transformations, including locality and reuse analysis, to determine the proper number of streams. The mechanism exploits effective data prefetching on different types of streams, based on compiler static analysis and dynamic profiling information, in order to eliminate redundant prefetching and avoid cache pollution. The mechanism uses high-level transformations with integrated lower level cost analysis in the instruction scheduler to schedule prefetch instructions effectively.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for setting a maximum bus speed in a system, the method comprising:
detecting presence of at least one attached device;
determining a maximum bus speed, based on a number of detected devices present; and
resetting a bus to operate at the determined maximum bus speed.

2. The method of claim 1, wherein detecting presence of at least one attached device includes applying power to at least one attached device in order to detect card presence.

3. The method of claim 2, wherein the power applied to the at least one attached device is only enough power to sufficiently detect card presence.

4. The method of claim 1, wherein resetting the bus requires reconfiguring the bus at chip rest to operate at the determined maximum bus speed.

5. The method of claim 1, further comprising:
resetting the at least one attached device, wherein the resetting of the at least one attached device is done to remove any errors.

6. The method of claim 1, wherein the power applied to the at least one attached device is power applied in a normal startup sequence.

7. A data processing system for setting a maximum bus speed in a system, the apparatus comprising:
detecting means for detecting presence of at least one attached device;
determining means for determining a maximum bus speed, based on a number of detected devices present; and
resetting means for resetting a bus to operate at the determined maximum bus speed.

8. The apparatus of claim 7, wherein detecting presence of at least one attached device includes applying power to at least one attached device in order to detect card presence.

9. The apparatus of claim 8, wherein the power applied to the at least one attached device is only enough power to sufficiently detect card presence.

10. The apparatus of claim 7, wherein resetting the bus requires reconfiguring the bus at chip rest to operate at the determined maximum bus speed.

11. The apparatus of claim 7, further comprising:
resetting means for resetting the at least one attached device, wherein the resetting of the at least one attached device is done to remove any errors.

12. The apparatus of claim 7, wherein the power applied to the at least one attached device is power applied in a normal startup sequence.

13. A computer program product in a computer readable medium for minimizing effective memory latency, the computer program product comprising:
instructions for detecting presence of at least one attached device;
instructions for determining a maximum bus speed, based on a number of detected devices present; and
instructions for resetting a bus to operate at the determined maximum bus speed.

14. The computer program product of claim 13, wherein detecting presence of at least one attached device includes applying power to at least one attached device in order to detect card presence.

15. The computer program product of claim 14, wherein the power applied to the at least one attached device is only enough power to sufficiently detect card presence.

16. The computer program product of claim 13, wherein resetting the bus requires reconfiguring the bus at chip rest to operate at the determined maximum bus speed.

17. The computer program product of claim 13, further comprising:
instructions for resetting the at least one attached device, wherein the resetting of the at least one attached device is done to remove any errors.

18. The computer program product of claim 13, wherein the power applied to the at least one attached device is power applied in a normal startup sequence.

19. A data processing system for setting a maximum bus speed of the data processing system, the data processing system comprising:
a bus system;
an expansion board connected to the bus system for the addition of at least one device;
a processing unit; and
a memory coupled to the processing unit, wherein the memory includes a set of instructions;
wherein the processing unit executes the set of instructions to detect the presence of at least one attached device, determine a maximum bus speed, based on a number of detected devices present, and reset a bus to operate at the determined maximum bus speed.

20. The data processing system of claim 19, wherein the processing unit further executes the set of instructions to reset the at least one attached device, wherein the resetting of the at least one attached device is done to remove any errors.
